(19) United States
(12) Patent Application Publication
(10) Pub. No.: US 2013/0286992 A1
(43) Pub. Date: Oct. 31, 2013

(54) TRANSMISSION METHOD FOR CONTROL DATA IN A COMMUNICATION SYSTEM AND A BASE STATION THEREFOR, AND A PROCESSING METHOD FOR CONTROL DATA AND A TERMINAL THEREFOR

(71) Applicant: Sungkwon Hong, Seoul (KR)

(72) Inventor: Sungkwon Hong, Seoul (KR)

(21) Appl. No.: 13/978,974

(22) PCT Filed: Jan. 9, 2012
(86) PCT No.: PCT/KR12/00219

§ 371 Date: Jul. 10, 2013

(30) Foreign Application Priority Data
Jan. 10, 2011 (KR) 10-2011-0002477

(51) Int. Cl. H04W 72/04

(52) U.S. Cl. CPC H04W 72/0406
USPC 370/329

(57) ABSTRACT

The present invention relates to a communication system, and relates to a transmission and processing method for control data and to a base station and terminal for the same.

### CROSS-REFERENCE TO RELATED APPLICATIONS

This application is the National Stage Entry of International Application PCT/KR2012/000219, filed on Jan. 9, 2012, and claims priority from and the benefit of Korean Patent Application No. 10-2011-0002477, filed on Jan. 10, 2011, both of which are incorporated herein by reference in their entireties for all purposes as if fully set forth herein.

### BACKGROUND

1. Field

The present invention relates to a communication system, and more particularly to a method for transmitting control information and a base station for the same, and a method for processing control information and a user equipment for the same.

2. Discussion of the Background

With the progress of communication systems, consumers such as companies and individuals have used a wide variety of wireless terminals.

Current mobile communication systems such as a 3^{rd} Generation Partnership Project Long Term Evolution (3GPP LTE) and a 3GPP LTE Advanced (LTE-A) need to develop a technology for a system capable of transmitting a large amount of data coming close to that transmitted through a wired communication network, as a high-speed and high-capacity communication system capable of transmitting and receiving various data such as images and wireless data beyond voice-oriented services. Also, in the current mobile communication systems, an appropriate error detection scheme which can improve system performance by minimizing information loss and increasing system transmission efficiency, becomes an essential element.

### SUMMARY

In accordance with an aspect of the present invention, there is provided a method for transmitting control information in a communication system where communication is performed by using two or more component carriers. The method includes: receiving, as an input, coefficients required to indicate resource allocation, and encoding the coefficients into a resource allocation value of each of the two or more component carriers; generating one piece of resource allocation information by joint-encoding the resource allocation values; and transmitting control information including the resource allocation information to a user equipment through a control channel.

In accordance with another aspect of the present invention, there is provided a method for processing control information in a communication system where communication is performed by using two or more component carriers. The method includes: receiving control information including resource allocation information from a base station through a control channel; decoding a resource allocation value of each of the two or more component carriers from the resource allocation information of the control information by using joint-decoding; and decoding coefficients required to indicate resource allocation on the two or more component carriers from the decoded resource allocation value of each of the two or more component carriers.

In accordance with still another aspect of the present invention, there is provided an apparatus for allocating resources in a communication system where communication is performed by using two or more component carriers. The apparatus includes: a first encoder for receiving, as an input, coefficients required to indicate resource allocation, and encoding the coefficients into a resource allocation value of each of the two or more component carriers; and a joint encoder for generating one piece of resource allocation information by joint-encoding the resource allocation values.

In accordance with yet another aspect of the present invention, there is provided an apparatus for decoding resource allocation information in a communication system where communication is performed by using two or more component carriers. The apparatus includes: a joint decoder for decoding a resource allocation value of each of the two or more component carriers from resource allocation information of control information received from a base station by using joint-decoding; and a first decoder for decoding coefficients required to indicate resource allocation on the two or more component carriers from the resource allocation value of each of the two or more component carriers which has been decoded by the joint decoder.

### BRIEF DESCRIPTION OF THE DRAWINGS

FIG. 1 is a view schematically illustrating a wireless communication system, to which exemplary embodiments of the present invention are applied.

FIG. 2 is a conceptual view illustrating the aggregation of component carriers and scheduling between component carriers in a wireless communication system according to an embodiment of the present invention.

FIG. 3 is a view illustrating a structure of one Physical Downlink Control CHannel (PDCCH) including resource allocation information of two or more component carriers according to another embodiment of the present invention.

FIG. 4 is a view illustrating a structure of a PDCCH according to still another embodiment of the present invention, which corresponds to an example of the PDCCH illustrated in FIG. 2.

FIG. 5 is a view illustrating a configuration of an apparatus for allocating resources, which generates the resource allocation information of the resource allocation field illustrated in FIG. 3 and the resource allocation information of the resource allocation field illustrated in FIG. 4, according to still another embodiment of the present invention.

FIG. 6 is a view illustrating a configuration of an apparatus for allocating resources, which generates the resource allocation information of the resource allocation field illustrated in FIG. 3 and the resource allocation information of the resource allocation field illustrated in FIG. 4, according to yet another embodiment of the present invention.

FIG. 7 is a flowchart illustrating a method for transmitting resource allocation information through one PDCCH of two or more component carriers, according to still another embodiment of the present invention.

FIG. 8 is a flowchart illustrating a method for processing one PDCCH including resource allocation information of two or more component carriers, according to still another embodiment of the present invention.

FIG. 9 is a view illustrating a configuration of an apparatus for decoding resource allocation information according to still another embodiment of the present invention.

FIG. 10 is a view illustrating a configuration of an apparatus for decoding resource allocation information according to yet another embodiment of the present invention.

FIG. 11 is a block diagram illustrating a configuration of a Base Station (BS) which generates control information in downlink, according to still another embodiment of the present invention.

FIG. 12 is a block diagram illustrating a configuration of a User Equipment (UE) according to still another embodiment of the present invention.

FIG. 13 is a block diagram schematically illustrating a configuration of a wireless communication system, by which exemplary embodiments of the present invention are implemented.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

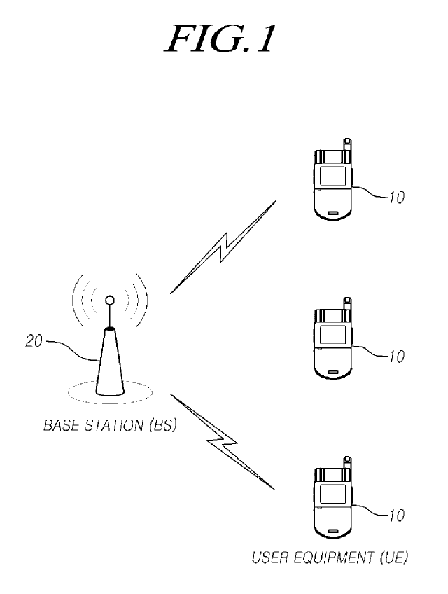

FIG. 1 illustrates a wireless communication system, to which exemplary embodiments of the present invention are applied.

The wireless communication system is widely arranged in order to provide various communication services, such as voice, packet data, and the like.

Referring to FIG. 1, in this specification, a User Equipment (UE) 10 has a comprehensive concept implying a user terminal in wireless communication. Accordingly, the UEs should be interpreted as having the concept of including a Mobile Station (MS), a User Terminal (UT), a Subscriber Station (SS), a wireless device, and the like in Global System for Mobile Communications (GSM) as well as User Equipments (UEs) in Wideband Code Division Multiple Access (WCDMA), Long Term Evolution (LTE), High Speed Packet Access (HSPA), and the like.

In this specification, the UE 10 and a Base Station (BS) 20, which are two transmission and reception subjects used to implement a technology or a technical idea described in this specification, are used as a comprehensive meaning, and are not limited by a particularly designated term or word.

An embodiment of the present invention may be applied to both the field of asynchronous wireless communications which have gone through GSM, WCDMA and HSPA, and evolve into Long Term Evolution (LTE) and Long Term Evolution-Advanced (LTE-A), and the field of synchronous wireless communications which evolve into Code Division Multiple Access (CDMA), CDMA-2000 and Ultra Mobile Broadband (UMB). The present invention should not be interpreted as being limited to or restricted by a particular wireless communication field, but should be interpreted as including all technical fields to which the spirit of the present invention can be applied.

Meanwhile, in an example of a wireless communication system, to which an embodiment of the present invention is applied, one radio frame or one wireless frame may include 10 subframes, and one subframe may include 2 time slots.

The subframe is a basic unit of data transmission, and DownLink (DL) or UpLink (UL) scheduling is performed in a unit of subframe. One slot may include multiple Orthogonal Frequency Division Multiplexing (OFDM) symbols in the time domain, and may include at least one subcarrier in the frequency domain. One slot may include 7 or 6 OFDM symbols.

For example, when a subframe includes 2 time slots, each time slot may include 7 symbols in the time domain and may include 12 subcarriers in the frequency domain. The time-frequency region defined by one slot as described above can be referred to as a “Resource Block (RB).” However, the time-frequency region according to the present invention is not limited thereto.

A Physical Downlink Control CHannel (PDCCH) which is one of control channels through which control information is transmitted, has various Downlink Control Information (DCI) formats and provides UE-specific control information, as described below. When the UE-specific control information is transmitted to the UE, the PDCCH provides information that the UE requires in order to decode a Physical Downlink Shared CHannel (PDSCH) or a Physical Uplink Shared CHannel (PUSCH), and simultaneously, provides control information required for communication to the UE.

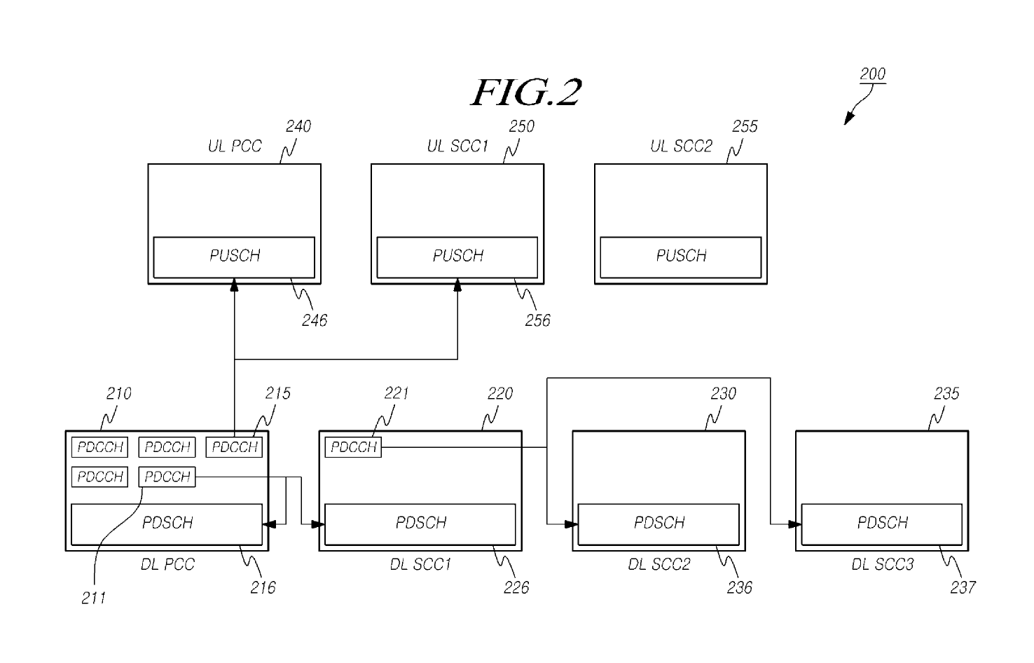

FIG. 2 is a conceptual view illustrating the aggregation of component carriers and scheduling between component carriers in a wireless communication system according to an embodiment of the present invention.

The wireless communication system 200 according to an embodiment of the present invention may correspond to carrier aggregation such that the wireless communication system 200 has an M number of DL component carriers in DL as illustrated in FIG. 2 (M is a natural number greater than 0, for example, a natural number having a value of 1 to 5, but is not limited to this example) and has an N number of UL component carriers in UL (N is a natural number greater than 0, for example, a natural number having a value of 1 to 5, but is not limited to this example). At this time, there may exist an asymmetrical situation in which the number of UL component carriers differs from that of DL component carriers. Specifically, M and N may have different values.

The carrier aggregation allows a Frequency Division Duplex (FDD) system to be configured by combining multiple bands, instead of configuring the FDD system by assigning one band or carrier in DL and in UL. Accordingly, the carrier aggregation can increase the communication quality and capacity. Meanwhile, Time Division Duplex (TDD) follows a scheme for extending an existing single-band or carrier allocated to the entirety of UL and DL.

In carrier aggregation, the maximum number of component carriers allocable to a particular UE is different for each UE, and such a maximum carrier set may be defined differently for each UE. The maximum carrier set allocable to the particular UE may be defined as a configuration component carrier set.

Referring again to FIG. 2, each of an M number of DL component carriers 210, 220, 230 and 235 includes a data channel (PDSCH). Meanwhile, each of DL component carriers 210, 220, 230 and 240 may include a control channel (PDCCH) as in the case of the particular component carriers 210 and 220, or may not include a control channel (PDCCH) as in the case of the other component carriers 230 and 235. In other words, all of the DL component carriers may include control channels, or only some of all the DL component carriers may include control channels.

Each of UL component carriers 240, 250 and 255 includes a data channel. Meanwhile, each of the UL component carriers 240, 250 and 255 may include or may not include a control channel. In other words, all of the UL component carriers 240, 250 and 255 may include control channels, or only some of all the UL component carriers 240, 250 and 255 may include control channels.

Meanwhile, in UL carrier aggregation and DL carrier aggregation, a Primary Component Carrier (PCC) and Secondary Component Carrier (SCC) may exist. The PCC signifies a component carrier which plays a major role in the transmission of control information and data in the case of communication between the BS and the UE, and may be configured in a UE-specific manner. A component carrier other than the PCC is defined as the SCC. The PCC and the SCC have no absolute meaning, but have a relative meaning.

Referring to FIG. 2, the number of the DL component carriers 210, 220, 230 and 235 may be equal to 4 (M=4), and that of the UL component carriers 240, 250 and 255 may be equal to 3 (N=3). Among the DL component carriers 210, 220, 230 and 235, the DL component carrier denoted by reference numeral 210 is a DL PCC, and the other DL component carriers 220, 230 and 235 are DL SCCs.

Meanwhile, among the UL component carriers 240, 250 and 255, the UL component carrier denoted by reference numeral 240 is a UL PCC, and the other UL component carriers 250, 255 are UL SCCs.

The DL PCC 210 is a single component carrier, but may allocate both DL grants and UL grants for not only the UL PCC 240 but also the other SCCs 220, 230, 235, 250 and 255, through cross-carrier scheduling. The UL PCC 240 is a single component carrier, but may be allocated all PUCCHs (Physical Uplink Control Channels) in UL through appropriate resource allocation (explicit or implicit resource allocation). Here, the term “explicit” signifies a case of clearly reporting the resource allocation through upper layer signaling. The term “implicit” signifies a case of reporting the allocation according to previously-determined rules including a position in a control region of a PDCCH and the like.

For example, after control information for communication between the BS and the UE is semi-statically transmitted to the UE through the upper layer signaling, a control channel is required to transmit dynamic resource allocation information on an allocated shared channel and control information required for transmission. Such a control channel corresponds to a Physical Downlink Control CHannel (PDCCH). Downlink control channels, through each of which control information is transmitted, include a Physical Control Format Indicator CHannel (PCFICH), a Physical Hybrid ARQ Indicator CHannel (PHICH), and the like, as well as the Physical Downlink Control CHannel (PDCCH).

The PDCCH is located at a certain part (search space) of a control region in a subframe, and the UE decodes the PDCCH by using blind decoding. The PDCCH has various DCI formats, and provides common control information or UE-specific control information. When the UE-specific control information is transmitted through the PDCCH, the PDCCH provides information that the UE requires in order to decode a PDSCH or a PUSCH, and simultaneously, provides control information required for communication to the UE.

It is assumed that the PDCCH is physically located in a particular region (a preset number of symbols at a front part of a subframe) of the subframe. However, the PDCCH may be defined in a new form by changing a region in which the PDCCH exists or a physical configuration format of the PDCCH.

All DCI formats of the PDCCH for the transmission of DL data are defined as a DL grant, and all DCI formats of the PDCCH for the transmission of UL data are defined as a UL grant.

Meanwhile, in the carrier aggregation, a scheme for transmitting control information is extended to multiple component carriers. Accordingly, it is possible to perform cross-carrier scheduling which is scheduling from one component carrier to another component carrier. It is possible to perform the cross-carrier scheduling by adding a Carrier Indicator Field (CIF), which is carrier identification information as described in detail below, to a payload of the PDCCH. Although the CIF is not limited to a particular number of bits, the CIF may be allocated, for example, 3 bits, and may indicate a maximum of 5 component carriers. In the CIF which is the carrier identification information, only 5 values among available values of 0 to 7 may be practically allocated to the component carriers. Hereinafter, the carrier identification information is referred to as the “CIF,” but the carrier identification information according to the present invention is not limited thereto.

Meanwhile, one PDCCH may designate a DL scheduling assignment for one component carrier, or a UL scheduling grant for the one component carrier. Otherwise, the one PDCCH may designate a DL scheduling assignment for two or more component carriers, or a UL scheduling grant for the two or more component carriers.

For example, the DL PCC 210 may include, in a control region thereof, a first PDCCH 211 including a CIF indicating the DL PCC 210 and the DL SCC1 220 and a second PDCCH 215 including a CIF indicating the UL PCC 240 and the UL SCC1 250. The DL SCC1 220 may include, in the control region thereof, a third PDCCH 221 indicating the DL SCC2 230 and the DL SCC3 235. It goes without saying that component carriers may include other PDCCHs which are not described above.

Each of the PDCCHs 211, 215 and 221 provides the UE with information for decoding both a shared channel (e.g., first to fourth PDSCHs 216, 226, 236 and 237) included in the component carrier indicated by the CIF and first and second PUSCHs 246 and 256, simultaneously with control information required for communication.

When one PDCCH schedules two or more component carriers as described above, a CIF which is carrier identification information may indicate the two or more component carriers. For example, while the length of a CIF is maintained as 3 bits, some of values of the CIF may be used to schedule the two or more component carriers. Otherwise, a newly-defined CIF of four or more bits may be used to schedule the two or more component carriers. Otherwise, a field other than the CIF of the PDCCH may be defined in order to indicate the two or more component carriers. Otherwise, a message (e.g., RRC signaling) of another layer (e.g., an upper layer) may be used to indicate the two or more component carriers.

When the two or more component carriers are indicated by using the CIF in any form, for example, CIF=5 may indicate the DL PCC 210 and the DL SCC1 220 or the UL PCC 240, and CIF=6 may indicate the DL SCC2 230 and the DL SCC3 235, or the UL SCC1 250 and the UL SCC2 255. Here, a combination of the two or more component carriers that the value of the CIF (or CIF value) indicates, is not limited to the above examples, but may be diversified. For example, the value of the CIF may indicate only one component carrier. In other words, each of CIF values of 0 to 4 may indicate one of a maximum of 5 component carriers.

Without using the CIF, control information of one or more component carriers may be transmitted through one PDCCH. This is a scheme in which upper layer signaling (or RRC signaling) is used to report that control information of one or more component carriers is transmitted through one PDCCH in a manner unique to a specific UE (or in a UE-specific manner). In this scheme, which PDCCH format is used to transmit control information of two or more component carriers may be also signaled in the UE-specific manner. Here, the CIF may not be used for indicating the two or more component carriers. When there is no CIF, a DL component carrier having the PDCCH and a UL component carrier in a linkage relation with the DL component carrier become component carriers that the PDCCH automatically indicates. When the one PDCCH is used to transmit the control information of the one or more component carriers through the upper layer signaling without the CIF as described above, not only the automatically-indicated component carriers as described above but also an additional component carrier are included in the upper layer signaling, and then, the upper layer signaling including them may be transmitted.

In the above description, each component carrier may not have the existing form in which the PDCCH has the control region and the control information is transmitted through the PDCCH, but may have a new form in which the component carrier has a different control region or a scheme for configuring a different PDCCH. Otherwise, each component carrier may be a new component carrier in which the transmission of the control information in the form of the PDCCH does not exist.

As described above, one PDCCH may allocate a DL scheduling assignment (i.e., a DL grant) for one component carrier, or a UL scheduling assignment (i.e., a UL grant) for the one component carrier. Otherwise, the one PDCCH may designate a DL scheduling assignment for two or more component carriers, or a UL scheduling assignment for the two or more component carriers. In other words, a DCI message of the one PDCCH may include the DL scheduling assignment including PDSCH resource allocation on the two or more component carriers. Otherwise, the DCI message of the one PDCCH may include the UL scheduling grant including PUSCH resource allocation on the two or more component carriers. Otherwise, the DCI message of the one PDCCH may mixedly include a DL scheduling assignment including PDSCH resource allocation on one or more component carriers and a UL scheduling grant including PUSCH resource allocation on the one or more component carriers.

A DL scheduling assignment (i.e., a DL grant) included in one PDCCH may include at least one of DL resource allocation information (resource block allocation) reporting an RB in which the UE must receive a PDSCH, modulation and encoding schemes, power transmission for PUCCH (PUCCH transmit power control), and a Radio Network Temporary Identity (RNTI) of the UE which must receive the relevant PDSCH. However, the DL scheduling assignment included in the one PDCCH according to the present invention is not limited thereto. Here, the RNTI is a kind of IDentification (ID) in a wireless network, and an RNTI for distinguishing between UEs is referred to as a “Cell RNTI (C-RNTI).” A C-RNTI is mainly used for specifying a UE in the PDCCH, and the RNTI is included in the PDCCH in the form of masking a Cyclic Redundancy Check (CRC) field with the RNTI. Meanwhile, the UL scheduling grant included in the one PDCCH may include at least one of UL resource allocation information reporting an RB that the UE is to have to use for PUSCH transmission, hopping information reporting whether frequency hopping is used for UL PUSCH transmission, and an RNTI of the UE which transmits the relevant PUSCH. However, the UL scheduling grant included in the one PDCCH according to the present invention is not limited thereto.

Hereinafter, as an example where one PDCCH includes a DL scheduling assignment and/or a UL scheduling assignment for two or more component carriers, the one PDCCH including resource allocation information of the two or more component carriers including one PDCCH will be described. However, the one PDCCH including the DL scheduling assignment and/or the UL scheduling assignment for the two or more component carriers according to the present invention is not limited thereto, and may include one of other pieces of control information.

For example, in relation to the DL scheduling assignment, control information (i.e., DCI) of a PDCCH may have a DCI format 1A expressing a resource indicator RIV in a contiguous resource allocation field, or may have a DCI format 1 supporting non-contiguous resource allocation. Meanwhile, in relation to the UL scheduling grant, control information (i.e., DCI) of a PDCCH may have a DCI format 0 granting UL contiguous resource allocation. In this specification, DCI formats include DCI formats, which are currently prescribed, or are being discussed, or will be newly defined in the future, as well as the formats as described above.

One PDCCH carries one message having one of the DCI formats. Because multiple UEs may be simultaneously scheduled in both downlink and uplink, there is a possibility that multiple scheduling messages will be transmitted in each subframe. Each scheduling message is transmitted through a separate PDCCH. Accordingly, it is typical that multiple PDCCH transmissions are simultaneously performed in each cell.

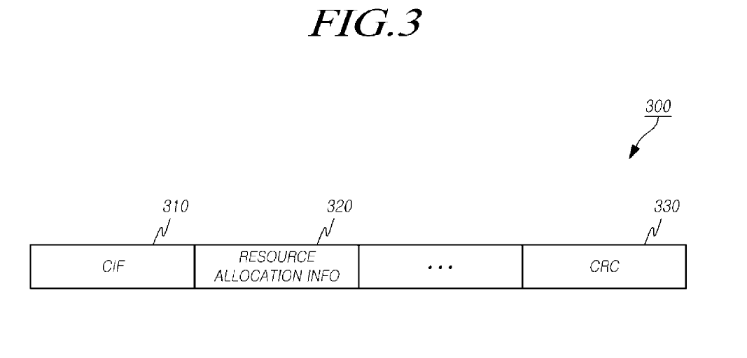

FIG. 3 is a view illustrating a structure of one PDCCH including resource allocation information of two or more component carriers according to another embodiment of the present invention.

Referring to FIG. 3, the one PDCCH as described above with reference to FIG. 2 transmits DCI 300 in a particular format, such as scheduling determination and a power control command.

The DCI 300 in the particular format may include a CIF field 310, a resource allocation field 320, and a CRC field 330. The DCI 300 may include a payload other than the CIF field 310, the resource allocation field 320 and the CRC field 330, although not illustrated in FIG. 3. However, the DCI 300 according to the present invention is not limited thereto.

The CIF field 310 may indicate two or more component carriers, as described above. Meanwhile, when a DCI 300 assigns DL scheduling by using a C-RNTI with which the CRC field 330 is masked, the CRC field 330 reports the identity of a UE which receives a PDSCH. When the DCI 300 assigns a UL scheduling grant, the CRC field 330 reports an RNTI of a UE which transmits a PUSCH. Here, the UEs which receive the PDSCH during the DL scheduling assignment, or the UEs which transmit the PUSCH during the UL scheduling assignment may be one in number, but may be two or more in number. When the UEs are two or more in number, an RNTI 330 of the two or more UEs may be defined. At this time, the two or more UEs belonging to the identical RNTI 330 may share another payload of a PDCCH, as well as resource allocation information. However, the two or more UEs belonging to the identical RNTI 330 according to the present invention are not limited thereto.

The resource allocation field 320 includes resource allocation information used for DL transmission or for the transmission of DL data.

Specifically, a resource region for resource allocation may be formed based on a time-frequency unit of a Resource Block (RB). In the case of broadband, the number of RBs increases and the amount of bits required to express resource allocation information may also increase. Accordingly, several RBs may be combined and processed as a Resource Block Group (RBG). The resource allocation information indicating such an RB or RBG may be transmitted in the form of a Resource Indication Value (RIV) or a resource allocation value in a resource allocation field 320 of a PDCCH. Considered bandwidths are 1.4, 3, 5, 10, 15 and 20 MHz. When each of the bandwidths is expressed by using the number of RBs, the bandwidths of 1.4, 3, 5, 10, 15 and 20 MHz correspond to 6, 15, 25, 50, 75 and 100 RBs, respectively. When the size of RBG is expressed by using the number of RBs corresponding to each of the bandwidths, 6, 15, 25, 50, 75 and 100 RBs correspond to sizes of RBGs of 1, 2, 2, 3, 4 and 4, respectively. Accordingly, the bandwidths of 1.4, 3, 5, 10, 15 and 20 MHz correspond to 6, 8, 13, 17, 19 and 25 RBGs, respectively.

According to a scheme expressing how resources are allocated to the resource allocation field 320, resource allocation schemes may belong to different types (type 0, type 1, and type 2). In this specification, the schemes for expressing resource allocation information in the resource allocation field 320 are not limited to the three types, but may include any present or future resource allocation schemes.

Type 0 among the different types of resource allocation schemes indicates a resource allocation region in a bitmap format. Specifically, with respect to each RB or each RBG, resource allocation is expressed to be 1, and non-resource allocation is expressed to be 0, and thereby resource allocation may be represented over the entire band.

Type 1 corresponding to another resource allocation scheme indicates a resource allocation region in a periodic format. Specifically, type 1 expresses resource allocation which has a cycle of a predetermined value P and has a form distributed at regular intervals in the entire allocation region. Typically, when type 0 and type 1 are used together, a differentiation bit for distinguishing type 0 from type 1 may be added.

Type 2 corresponding to still another resource allocation scheme is used to allocate a contiguous resource region having a predetermined length by using an offset and a length.

When type 2 corresponding to still another resource allocation scheme is used, a resource allocation field in the case of contiguous resource allocation may include an RIV (i.e., RIV_{LTE}(L_{CRBs}, RBₛₜₐᵣₜ, N_{RB}^{DL})) or a resource allocation value, which corresponds to a start point (i.e., a starting RB RBₛₜₐᵣₜ) of an RBG and the length of contiguous virtual RBs (i.e., a length L_{CRBs} in terms of virtually contiguously allocated RBs).

At this time, RIV_{LTE}(L_{CRBs}, RBₛₜₐᵣₜ, N_{RB}^{DL}) may be expressed by Equation (1) below.

if (L_{CRBs}−1)≦└N_{RB}^{DL}/2┘ then

RIV_{LTE}(L_{CRBs},RBₛₜₐᵣₜ,N_{RB}^{DL})=N_{RB}^{DL}(L_{CRBs}−1)+RBₛₜₐᵣₜ

else

RIV_{LTE}(L_{CRBs},RBₛₜₐᵣₜ,N_{RB}^{DL})=N_{RB}^{DL}(N_{RB}^{DL}−L_{CRBs}+1)+(N_{RB}^{DL}−1−RBₛₜₐᵣₜ)

where L_{CRBs}≧1 and shall not exceed N_{VRB}^{DL}−RBₛₜₐᵣₜ, (1)

Here, └x┘ which signifies the floor of x, represents the largest integer among integers which is less than or equal to a number within └ ┘. N_{VRB}^{DL} represents a maximum length of a virtual connected RBGs. N_{RB}^{DL} represents the total number of RBGs, and corresponds to n. “DL” signifies DL, but the meaning of “DL” is not limited only to DL.

For example, in the case of a total of 15 RBGs where RBₛₜₐᵣₜ representing a start point of an RBG is equal to 5 and L_{CRBs} representing the length of contiguous virtual RBs is is equal to 3, RIV_{LTE} (L_{CRBs}, RBₛₜₐᵣₜ, N_{RB}^{DL})=15(3−1)+5=35.

In 3GPP LTE Rel-8/9, only a resource allocation method of type 2 is applied to UL. Meanwhile, the resource allocation scheme of type 2 as described above is a UL resource allocation scheme, and is also referred to as “UL resource allocation type 0.” However, the UL resource allocation type 0 is identical to the resource allocation scheme of type 2 in a resource allocation scheme, and thus is commonly called “type 2” in this specification.

Type 2 refers to only resource allocation applied to one contiguous block, but 3GPP LTE-A Rel-10 enables UL resource allocation applied to non-contiguous multiple RBs.

This resource allocation is referred to as “non-contiguous resource allocation,” and each set of blocks among multiple sets of non-contiguous blocks is defined as a cluster. Type 0 may express non-contiguous resource allocation. However, the resource allocation of type 0 enables all available non-contiguous allocation in the entire range of given RBGs, whereas non-contiguous resource allocation considered in LTE-A considers only a limited number of clusters (e.g., two clusters).

Enumerative source encoding or a Channel Quality Indicator (CQI) based algorithm is used to encode/decode an RIV for the non-contiguous resource allocation using a limited number of clusters. The scheme for enumerative source encoding is already included in the existing LTE standard as a scheme for expressing a CQI, so that the scheme may be readily standardized and may decrease complexity and may ensure stable implementation in terms of the extension of a previously-implemented system. For the CQI, the enumerative source encoding may signify a scheme that is performed in a unit of subband in a frequency domain, and expresses the selection of a predetermined number (M) of subbands from a given subband region (1 through N). The enumerative source encoding may be expressed as follows.

A value may be calculated for an N number of subband indices {Sₖ}ₖ₌₀^{M-1} (1≦sₖ≦N, sₖ<sₖ₊₁) aligned in ascending order, by using Equation (2) below.

$$r = {\sum }_{i = 0}^{M - 1} 〈 \begin{matrix}N - {s}_{i} \\ M - i\end{matrix} 〉 \qquad ( 2 )$$

Here,

$$〈 \begin{matrix}x \\ y\end{matrix} 〉 = \{ \begin{matrix}( \begin{matrix}x \\ y\end{matrix} ) = {}_{x}^{}{C}{}_{y}^{} & x \geq y \\ 0 & x < y ,\end{matrix}$$

and r has a range expressed by rε{0, . . . , (_{M}^{N}) −,}.

Accordingly, the resource allocation information in the UL resource allocation type 2 indicates two sets of RBs with each set including one or more contiguous RBGs of size P, to a UE scheduled in a UL system band N.

At this time, a resource allocation field of a scheduled UL grant includes a combinatorial index r corresponding to a start RBG index s₀ and an end RBG index s₁−1 of resource block set 1 and a start RBG index s₂ and end RBG index s₃−1 of resource block set 2, respectively. At this time, the combinatorial index r is defined by an equation

$$r = {\sum }_{i = 0}^{M - 1} 〈 \begin{matrix}N - {s}_{i} \\ M - i\end{matrix} 〉 \qquad ( 2 )$$

with M=4 and N=[N_{RB}^{UL}/P]+1.

Meanwhile, when the corresponding end RBG index is identical to the start RBG index, only one RBG is allocated as one set at the start RBG index.

The non-contiguous resource allocation scheme according to the enumerative source encoding as described above referred to as “UL resource allocation type 1.” However, the present invention is not limited to this term. In this specification, this non-contiguous resource allocation scheme is commonly called the “enumerative source encoding.”

Specifically, the scheme for enumerative source encoding is already included in the existing LTE standard as a scheme for expressing a CQI. Accordingly, when the scheme for enumerative source encoding is used to express an RB set or a cluster identically to a standardized scheme, an RB or an RBG in which the number of RB sets or that of clusters is equal to 1, may not be expressed. This is due to a condition that an identical value may not be substituted into Sₖ of the CQI based algorithm for expressing a CQI. Accordingly, in order to solve this problem, 1 is added to Sₖ₊₁ corresponding to an end point in Sₖ.

For example, in the case of a total of 15 RBGs, it may be presumed that a start point s₀=5 and an end point s₀−1=7 within a first cluster, and that a start point s₂=10 and an end point s₀−1=12 within a second cluster. At this time, 1 is added to a parameter corresponding to an end point, as in a case where s₁−1=7 becomes s₁=7+1=8. Accordingly, s₁−1 represents an originally intended end point of a cluster. Here, because N must be replaced by N+1 (N=[N_{RB}^{UL}/P]+1), a combinatorial index substituted into an actual equation becomes r=₁₅₊₁₋₅C₄+₁₅₊₁₋₈C₃+₁₅₊₁₋₁₀C₂+₁₅₊₁₋₁₃C₁=₁₁C₄+₈C₃+₆C₂+₃C₁=407.

A decoding process related to the above description may be expressed by Equation (3) below.

$${x}_{min} = 1 \\ for k = 0 to M - 1 , \\ x = {x}_{min} \\ p = 〈 \begin{matrix}N - x \\ M - k\end{matrix} 〉 \\ while p > r , \\ x = x + 1 \\ p = 〈 \begin{matrix}N - x \\ M - k\end{matrix} 〉 \\ end \\ {s}_{k} = x \\ {x}_{min} = {s}_{k} + 1 \\ r = r - p \\ end \qquad ( 3 )$$

The resource allocation field 320 of the PDCCH 300 which has been described with reference to FIG. 3 may express control information (e.g., resource allocation information) of two or more DL or UL component carriers in any scheme of the resource allocation schemes as described above. Specifically, the resource allocation field 320 may express contiguous or non-contiguous resource allocation information by using DCI of a certain format.

A UE may interpret the resource allocation field 320 according to the searched PDCCH DCI format.

The resource allocation field 320 of the PDCCH 300 may include a resource allocation header field and information configuring actual resource block allocation.

PDCCH DCI formats 1, 2, 2A and 2C, each having resource allocation type 0 and PDCCH DCI formats 1, 2, 2A and 2C, each having resource allocation type 1 all have the same format, and are distinguished from each other by using a single bit resource allocation header field according to a DL system bandwidth. In this case, type 0 may have “0” as the value of a resource allocation header field, and type 1 may have “1” as that of a resource allocation header field.

PDCCHs having PDCCH DCI formats 1A, 1B and 1C, and PDCCH DCI formats 1D, 2A, 2B and 2C employ a resource allocation scheme of type 2. In this case, PDCCH DCI formats using the resource allocation scheme of type 2 do not have a resource allocation header field.

Meanwhile, type 2 (or UL resource allocation type 0) and the enumerative source encoding (or UL resource allocation type 1) are used as a UL resource allocation scheme. A PDCCH DCI format using type 2 and the enumerative source encoding may be a DCH format 0.

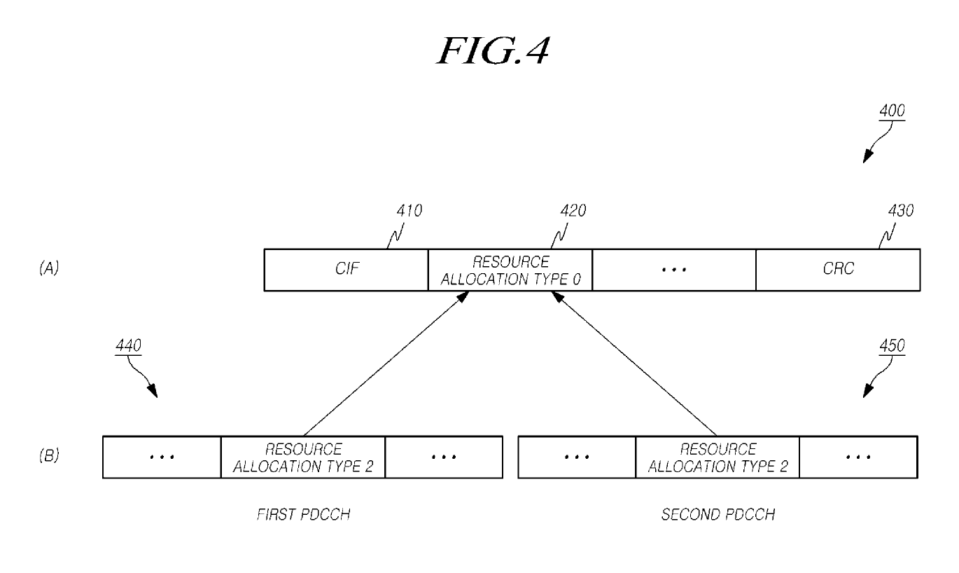

FIG. 4 is a view illustrating a structure of a PDCCH according to still another embodiment of the present invention, which corresponds to an example of the PDCCH illustrated in FIG. 2.

(A) of FIG. 4 illustrates one PDCCH 400 on which one PDCCH includes control information of two or more component carriers. (B) of FIG. 4 illustrates two PDCCHs 440 and 450 on which one PDCCH includes control information of one component carrier.

The PDCCH 400 illustrated in (A) of FIG. 4 according to still another embodiment of the present invention includes a CIF field 410 and a CRC field 430 masked with a C-RNTI value, identically to the PDCCH 300 illustrated in FIG. 3. Also, the PDCCH 400 according to still another embodiment of the present invention may include a resource allocation type 0 field 420 which indicates resource allocation information. The resource allocation type 0 field 420 may perform joint encoding as described below, and may indicate resource allocation for two or more component carriers.

For example, when RAᵢ (1≦i≦m) represents an RIV or a resource allocation value of a resource allocation field which indicates resource allocation for a particular i-th component carrier, the resource allocation type 0 field 420 may be configured as shown in an equation below. In the equation below, when RAᵢ^{max} represents the maximum value of a resource allocation value of the particular i-th component carrier, a range of RAᵢ may be 0≦RAᵢ≦RAᵢ^{max}−1.

$$RA = {\sum }_{i = 2}^{m} ( {RA}_{i} \cdot ( {\prod }_{l = 1}^{i - 1} {RA}_{l}^{max} ) ) + {RA}_{1}$$

In the equation above, RA₁ represents a resource allocation value of a first component carrier, and the remaining part represents values obtained by sequentially multiplying resource allocation values of second to m component carriers by RA₁^{max} to RAₘ₋₁^{max}.

Meanwhile, when 1≦i≦m−1, the resource allocation type 0 field 420 may be expressed by an equation below.

$$RA = {\sum }_{i = 1}^{m - 1} ( {RA}_{i} \cdot ( {\prod }_{l = 0}^{i - 1} {RA}_{l}^{max} ) ) + {RA}_{0}$$

The equation above is identical to the previous equation except for 1≦i≦m−1.

For example, when m=2, RA₁ represents the resource allocation value of the first component carrier, the remaining part corresponds to a value calculated by using the resource allocation value RA₂ of the second component carrier and RA₁^{max}, and resource allocation values of the two component carriers of the resource allocation type 0 field 420 are expressed by RA₂×RA₁^{max}+RA₁. When m=3, resource allocation values of the three component carriers of the resource allocation type 0 field 420 are expressed by RA₃×RA₂^{max}×RA₁^{max}+RA₂×RA₁^{max}+RA₁. When RA₁^{max} to RAₘ₋₁^{max} are all identical, the equation above expresses a resource allocation value of each component carrier by using RAᵢ^{max} base numbers. In the case of a decimal number, a decimal number 123 may be expressed by 1×10²+2×10¹+3. Accordingly, a value of 1's place is equal to 3, a value of (10¹)'s place is equal to 2, and a value of (10²)'s place is equal to 1. Similarly, in the case of an m number of resource allocation values of the resource allocation type 0 field 420, a value of 1's place becomes RA₁, a value of (RAᵢ^{max})'s place becomes RA₂, a value of ((RAᵢ^{max})²)'s place becomes RA₃, and lastly, a value of ((RAᵢ^{max})^{m-1})'s place becomes RAₘ.

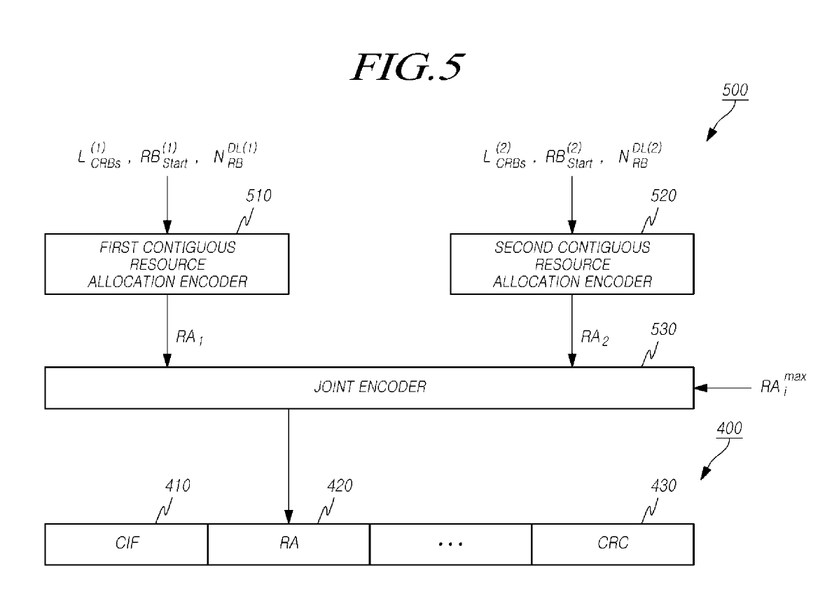

FIG. 5 is a view illustrating a configuration of an apparatus for allocating resources, which generates the resource allocation information of the resource allocation-type field illustrated in FIG. 3 and the resource allocation information of the resource allocation-type field illustrated in FIG. 4, according to still another embodiment of the present invention.

Referring to FIG. 5, an apparatus 500 for allocating resources generates resource allocation information illustrated in each of FIG. 3 and FIG. 4, and provides the generated resource allocation information to each of the resource allocation fields 320 and 420 of the PDCCHs 300 and 400. Hereinafter, a description will be made in such a manner that the apparatus 500 for allocating resources generates the resource allocation information and provides the generated resource allocation information to the resource allocation field 420 of the PDCCH 400 illustrated in FIG. 4. However, the present invention is not limited thereto.

The apparatus 500 for allocating resources includes a first contiguous resource allocation encoder 510, a second contiguous resource allocation encoder 520, and a joint encoder 530. In the apparatus 500 for allocating resources, the first contiguous resource allocation encoder 510, the second contiguous resource allocation encoder 520 and the joint encoder 530 may be implemented as one element or program, or as separate elements or programs, in software or hardware.

Particularly, the first contiguous resource allocation encoder 510 and the second contiguous resource allocation encoder 520 may perform encoding sequentially or parallely as one encoder. In other words, one encoder may receive, as input, coefficients required to calculate resource allocation information, and may sequentially or parallely encode resource allocation values of two or more component carriers.

The first contiguous resource allocation encoder 510 and the second contiguous resource allocation encoder 520 may encode contiguous resource allocation values RA₁ and RA₂ of a first component carrier and a second component carrier, respectively.

For example, in a DL resource allocation scheme of type 2 among resource allocation schemes, RAᵢ is an RIV (i.e., RIV_{LTE}(L_{CRBs}, RBₛₜₐᵣₜ, N_{RB}^{DL})), which indicates a start point (i.e., a starting RB RBₛₜₐᵣₜ) of an RBG and the length of contiguous virtual RBs (i.e., a length L_{CRBs} in terms of virtually contiguously allocated RBs), and N_{RB}^{DL}=100 and RAᵢ^{max}=5050 when a bandwidth of a component carrier in DL is equal to 20 MHz.

During contiguous resource allocation on the first component carrier, the first contiguous resource allocation encoder 510 may receive, as input, a start point RBₛₜₐᵣₜ⁽¹⁾ of an RBG, a length L_{CRBs}⁽¹⁾ of contiguous virtual RBs and N_{RB}^{DL}=100 representing the total number of RBs, may encode the received values in the DL resource allocation scheme of type 2 or the UL resource allocation scheme of type 0 among the resource allocation schemes as described above, and may calculate a contiguous resource allocation value RA₁. Similarly, during contiguous resource allocation on the second component carrier, the second contiguous resource allocation encoder 520 may receive, as input, a start point RBₛₜₐᵣₜ⁽²⁾ of an RBG, a length L_{CRBs}⁽²⁾ of contiguous virtual RBs and the total number N_{RB}^{DL} of RBs=100, may encode the received values in the DL resource allocation scheme of type 2 or the UL resource allocation scheme of type 0 among the resource allocation schemes as described above, and may calculate a contiguous resource allocation value RA₂. For example, RA₁ may be equal to 127 and RA₂ may be equal to 211.

The joint encoder 530 joint-encodes the contiguous resource allocation value of the first component carrier and the contiguous resource allocation value of the second component carrier, and thereby generates resource allocation information. The resource allocation information into which the joint encoder 530 has joint-encoded the two contiguous resource allocation values, is included in the resource allocation field 420 of the PDCCH 400 illustrated FIG. 4. For example, the resource allocation information into which the joint encoder 530 has joint-encoded the two contiguous resource allocation values, is obtained by 127×5050+211=641561.

The resource allocation information may be expressed as the joint-encoded value shown by the equation as described above in the resource allocation field 420, and thereby, one PDCCH may include resource allocation information of two or more component carriers.

Hereinafter, when the resource allocation information is expressed as the joint-encoded value shown by the equation as described above in the resource allocation field 420 and thereby, one PDCCH includes resource allocation information of two or more component carriers, a relation between a DCI format and a resource allocation scheme will be described.

For example, when one of the existing DCI formats is used, the resource allocation field 420 may use a DCI format among the existing DCI formats, which has a maximum value greater than a maximum value obtained by joint-encoding the resource allocation values of the two or more component carriers, which have been calculated by using is one of the existing resource allocation schemes.

Specifically, with respect to a DL PDSCH, the DCI format 1A may indicate that resource allocation is contiguous resource allocation. Accordingly, the DCI format 1A has

$${RA}_{i}^{max} = {log}_{2} \frac{{N}_{RB}^{DL} ( {N}_{RB}^{DL} + 1 )}{2}$$

as a maximum value of a resource allocation value. Accordingly, when a bandwidth of a component carrier in DL is equal to 20 MHz, N_{RB}^{DL}=100 and RAᵢ^{max}=5050. Accordingly, a maximum value representing resource allocation on the two component carriers is equal to 5050×5050=25502500.

Meanwhile, with respect to a DL PDSCH, the DCI format 1 may indicate that resource allocation is non-contiguous resource allocation. Similarly, when a bandwidth of a component carrier in DL is equal to 20 MHz and resources are allocated in a unit of RBG having N_{RB}^{DL}=100 and p=4, resources may be allocated by using a 25-bit bitmap. When resources are allocated in a DCI format by using the 25-bit bitmap, 2²⁵=33554432 and this value is less than the maximum value representing resource allocation on the two component carriers in the DCI format 1A (i.e., 2²⁵=33554432>25502500).

Accordingly, when the resource allocation in the DCI format 1 is not used in a bitmap format but is used as contiguous resource allocation, it is possible to allocate resources on a PDSCH of two component carriers.

In the case of changing a resource allocation scheme in the DCI format 1 to a scheme using the bitmap format and changing a scheme for resource allocation on the two component carriers to not a non-contiguous resource allocation scheme but a contiguous resource allocation scheme, upper layer signaling (e.g., RRC signaling) may change current conditions to UE-specific ones, it is possible to use a particular bit of one field of payloads of the DCI format 1, and a new 1-bit field may be defined in order to represent the particular bit.

Here, when resources include not RBs but RBGs in configuring contiguous resource allocation in the DCI format 1A, the value of RAᵢ^{max} becomes smaller and it is possible to allocate resources on a larger number of component carriers.

As described above, a case has been described as an example in which a resource allocation value RAᵢ of each of the two component carriers is expressed in the contiguous resource allocation scheme. However, a resource allocation value RAᵢ of each component carrier may express two or more clusters or RB sets by using the CQI based algorithm or the enumerative source encoding as described above.

In other words, the resource allocation field 420 may express a resource allocation value RAᵢ of each component carrier, which expresses the non-contiguous two or more clusters or resource block sets by using the CQI based algorithm or the enumerative source encoding as described above, by using non-contiguous joint-encoding, and thereby may express non-contiguous resource allocation on the two or more component carriers.

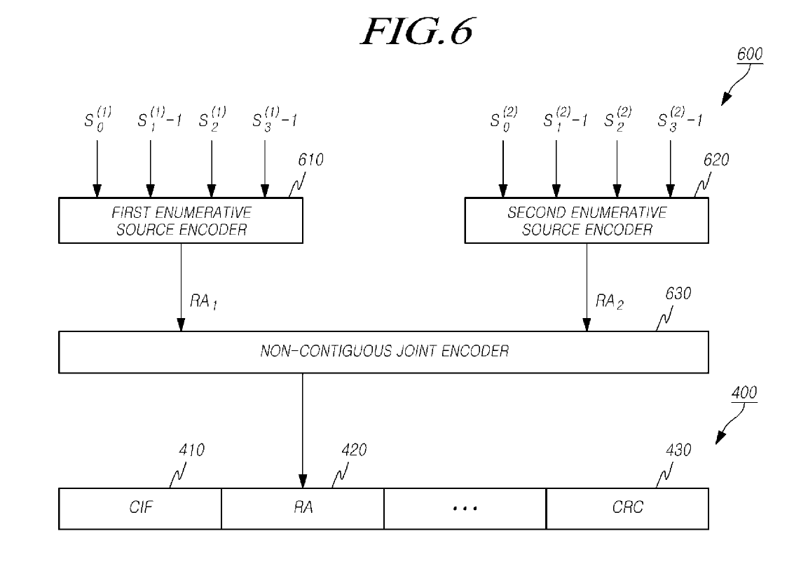

FIG. 6 is a view illustrating a configuration of an apparatus for allocating resources, which generates the resource allocation information of the resource allocation field illustrated in FIG. 3 and the resource allocation information of the resource allocation field illustrated in FIG. 4, according to yet another embodiment of the present invention.

Referring to FIG. 6, an apparatus 600 for allocating resources according to yet another embodiment of the present invention generates resource allocation information illustrated in each of FIG. 3 and FIG. 4, and provides the generated resource allocation information to each of the resource allocation fields 320 and 420 of the PDCCHs 300 and 400. Hereinafter, a description will be made in such a manner that the apparatus 600 for allocating resources generates the resource allocation information and provides the generated resource allocation information to the resource allocation field 420 of the PDCCH 400 illustrated in FIG. 4. However, the present invention is not limited thereto.

The apparatus 600 for allocating resources includes a first enumerative source encoder 610, a second enumerative source encoder 620, and a non-contiguous joint encoder 630.

When non-contiguous resources corresponding to two clusters are allocated on each component carrier, the first enumerative source encoder 610 and the second enumerative source encoder 620 may encode a resource allocation value RA₁ of a first component carrier having two clusters and a resource allocation value RA₂ of a second component carrier having two clusters, respectively.

During non-contiguous contiguous resource allocation on a first component carrier, the first enumerative source encoder 610 may receive, as input, start points S₀⁽¹⁾ and S₂⁽¹⁾ and end points S₁−1⁽¹⁾ and S₃−1⁽¹⁾ of the two clusters, may encode the received start points and end points by using the enumerative source encoding as described above, and thereby may calculate a non-contiguous resource allocation value RA₁. Similarly, during non-contiguous contiguous resource allocation on a second component carrier, the second enumerative source encoder 620 may receive, as input, start points S₀⁽²⁾ and S₂⁽²⁾ and end points S₁⁽²⁾−1 and S₃⁽²⁾−1 of the two clusters, may encode the received start points and end points by using the enumerative source encoding as described above, and thereby may calculate a non-contiguous resource allocation value RA₂. For example, RA₁ may be equal to 7567, and RA₂ may be equal to 267.

The non-contiguous joint encoder 630 receives, as input, the resource allocation value RA₁ of the first component carrier having the two clusters and the resource allocation value RA₂ of the second component carrier having the two clusters, which are respectively provided by the first enumerative source encoder 610 and the second enumerative source encoder 620, may joint-encode the received resource allocation values, and may generate resource allocation information. The resource allocation information into which the non-contiguous joint encoder 630 has joint-encoded the received resource allocation values, is included in the resource allocation field 420 of the PDCCH 400 as illustrated in FIG. 4.

For example, when non-contiguous resources corresponding to two clusters are intended to be allocated on each component carrier within a bandwidth of 20 MHz, if non-contiguous resources are allocated in a unit of RBG having p=4 and N_{RB}^{DL}=100, RAᵢ^{max}=14950. Accordingly, a resource allocation value RAᵢ of each component carrier having the two clusters may be calculated by performing the enumerative source encoding, and a value of the resource allocation field 420 may be calculated by joint-encoding the resource allocation values of the two or more component carriers.

For example, when the non-contiguous resource allocation values RA₁ and RA₂ of the two component carriers are equal to 7567 and 267 respectively, a resource allocation value of the resource allocation field 420 obtained after the non-contiguous joint encoder 630 joint-encodes the received non-contiguous resource allocation values may be equal to 7567×14950+267=113097017.

As described above, a case has been described as an example in which the apparatus 600 for allocating resources as illustrated in FIG. 6 performs non-contiguous resource allocation on the two component carriers. However, when non-contiguous resources corresponding to a k number of clusters (k is a natural number greater than 1) are allocated on each of two or more component carriers in a similar manner, resource allocation values of each component carrier having the k number of clusters are calculated by performing the enumerative source encoding, the resource allocation values are joint-encoded, and thereby, it is possible to express the k number of clusters on each of the two or more component carriers in the resource allocation field 420.

Here, although the resource allocation field 420 may use the existing DCI format as described above, it may use a DCI format of a new size.

The resource allocation field 420 as described above may be used to express not only contiguous or non-contiguous resource allocation for PDSCHs of the two or more DL component carriers, but also contiguous or non-contiguous resource allocation for a PUSCH of each of the two or more UL component carriers.

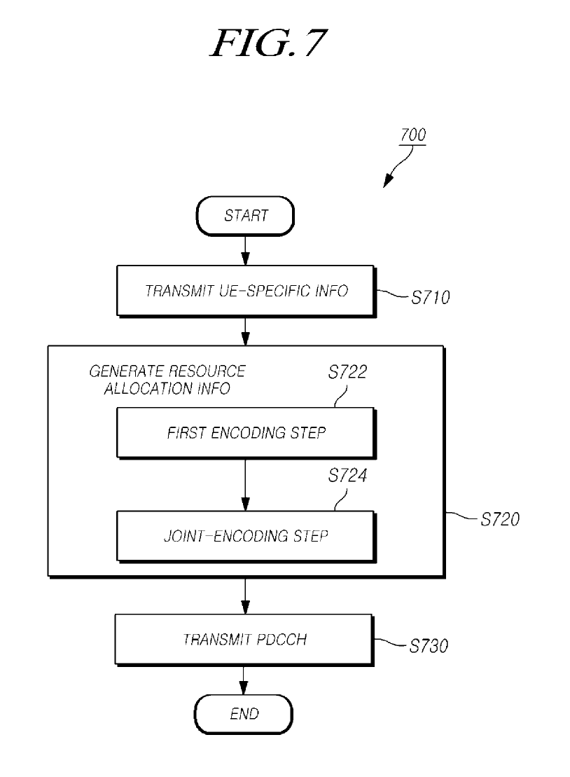

FIG. 7 is a flowchart illustrating a method for transmitting resource allocation information through one PDCCH of two or more component carriers, according to still another embodiment of the present invention.

Referring to FIG. 7, in the method 700 for transmitting resource allocation information through one PDCCH of two or more component carriers, according to still another embodiment of the present invention, a transmission device (e.g., the BS illustrated in FIG. 1) may transmit UE-specific information on resource allocation through the one PDCCH of the two or more component carriers to a reception device (e.g., the UE illustrated in FIG. 1), in step S710. At this time, the BS may transmit the UE-specific information to the UE through RRC signaling. However, the present invention is not limited to this configuration. Accordingly, the BS may transmit the UE-specific information to the UE through a physical layer signaling or signaling of an upper layer higher than the physical layer.

For example, during the contiguous resource allocation as described above, the UE-specific information may notify the UE of whether resource allocation information is to be represented, in such a manner that the resource allocation field in the DCI format 1 is allocated resources by using the DL resource allocation scheme of type 0 or 1, or in such a manner that the contiguous resource allocation values of the two or more component carriers are calculated by using the resource allocation scheme of type 2 and then the contiguous resource allocation values are joint-encoded by the joint encoder, as described above with reference to FIG. 5.

Then, the BS generates resource allocation information in step S720. Step S720 of generating the resource allocation information may include first encoding step S722 of encoding a resource allocation value of each component carrier and joint-encoding step S724 of joint-encoding resource allocation values of the two or more component carriers and thereby generating the resource allocation information.

In first encoding step S722, a resource allocation value of each component carrier may be encoded in an encoding method used by the first contiguous resource allocation encoder 510 or the second contiguous resource allocation encoder 520 as described above with reference to FIG. 5, or the resource allocation value of each component carrier may be encoded in an encoding method used by the first enumerative source encoder 610 or the second enumerative source encoder 620.

Also, in joint-encoding step S724, resource allocation values of the two or more component carriers may be joint-encoded in one of methods used by the joint encoders 530 and 630 as illustrated in FIG. 5 or FIG. 6, and thereby may generate resource allocation information.

Then, the BS may transmit a PDCCH in a DCI format, which includes the resource allocation information generated in step S720, to the UE on one component carrier, in step S730.

The step of transmitting a PDCCH may be generalized by step S730 as follows. The BS performs a step of adding a Cyclic Redundancy Check (CRC) for error detection to control information including the resource allocation information, a step of generating encoded data by channel-encoding the control information to which the CRC is added, a step of generating modulated symbols by modulating the encoded data, and a step of mapping the modulated symbols to physical resource elements. Then, the BS may transmit the control information to the UE.

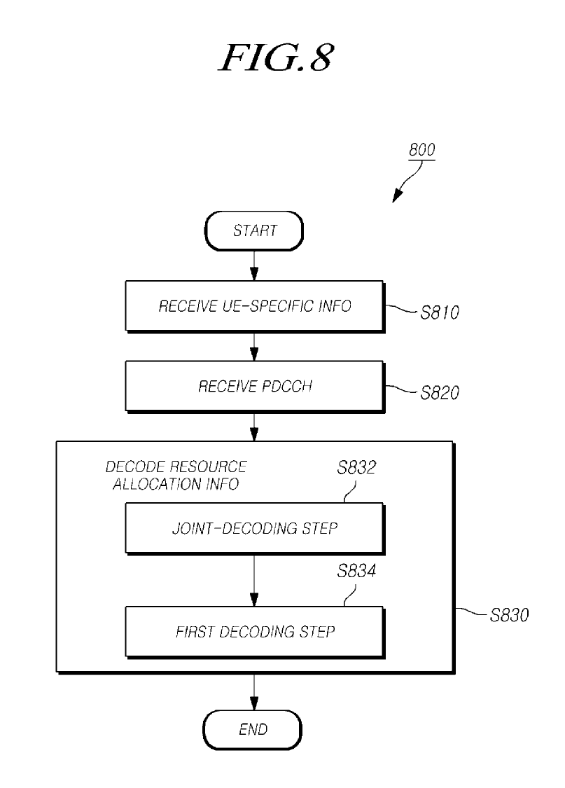

FIG. 8 is a flowchart illustrating a method for processing one PDCCH including resource allocation information of two or more component carriers, according to still another embodiment of the present invention.

Referring to FIG. 8, in the method 800 for processing one PDCCH including resource allocation information of two or more component carriers according to still another embodiment of the present invention, a reception device (e.g., the UE illustrated in FIG. 1) receives UE-specific information on resource allocation through the one PDCCH of the two or more component carriers from a transmission device (e.g., the BS illustrated in FIG. 1), in step S810.

The UE receives the PDCCH in the DCI format including the resource allocation information from the BS on one component carrier and processes the received PDCCH, in step S820.

The generalization of the method for processing control information in step s820 is as follows.

The UE performs: a step of demapping physical resource elements, through which the UE has received control information from the BS, to symbols (RE-to-Control Channel Element (CCE) demapping); a step of generating data by demodulating the demapped symbols; a step of channel-decoding the demodulated data and detecting whether an error has occurred, by checking a CRC of the channel-decoded demodulated data; and a step of acquiring necessary control information by removing the CRC from the decoded data.

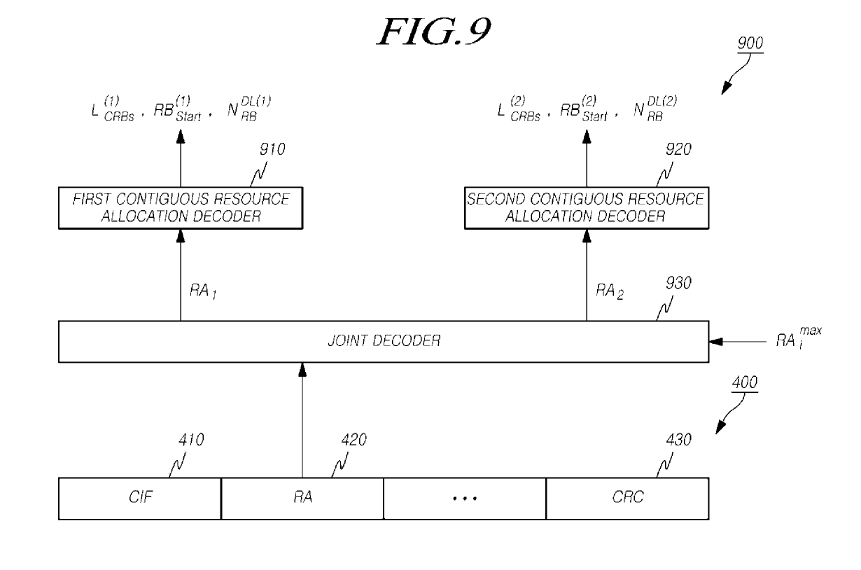

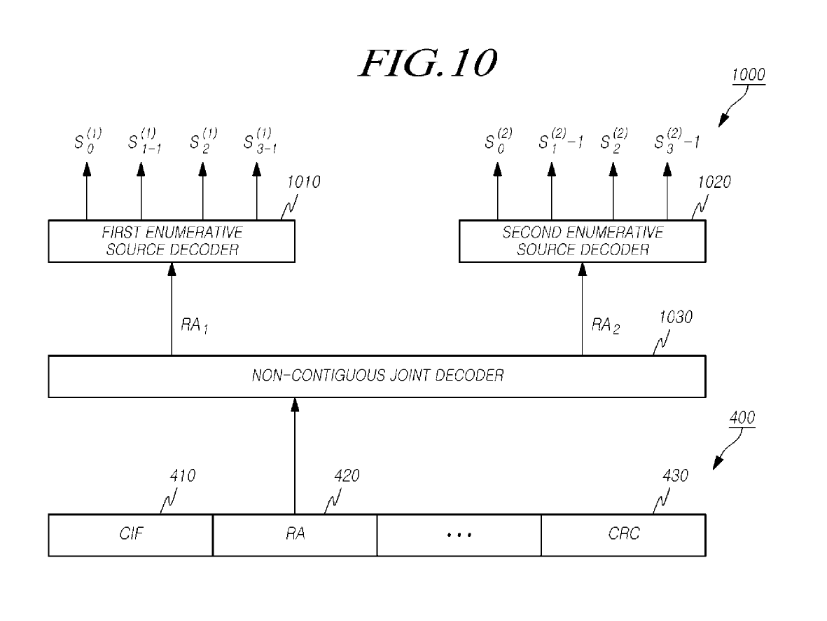

Then, the UE decodes resource allocation information from the control information of the acquired PDCCH, in step S830. Step S830 of decoding the resource allocation information from the control information of the PDCCH includes joint-decoding step S832 of decoding a resource allocation value of each of two or more component carriers from the resource allocation information of the control information by using joint-decoding, and first decoding step S834 of decoding coefficients required to indicate resource allocation on each of the two or more component carriers from the resource allocation value of each of the two or more component carriers. Step S830 of decoding the resource allocation information from the control information of the PDCCH will be described in detail with reference to apparatuses 900 and 1000 for decoding resource allocation information as described below with reference to FIG. 9 and FIG. 10. When the resource allocation information is decoded from the control information of the acquired PDCCH in step S830, use is made of the UE-specific information received from the BS in step S810.

FIG. 9 is a view illustrating a configuration of an apparatus for decoding resource allocation information according to still another embodiment of the present invention.

The apparatus 900 for decoding resource allocation information according to still another embodiment of the present invention decodes resource allocation information from control information of a PDCCH.

The apparatus 900 for decoding resource allocation information includes a joint decoder 930, a first contiguous resource allocation decoder 910, and a second contiguous resource allocation decoder 920. In the apparatus 900 for decoding resource allocation information, the joint decoder 930, the first contiguous resource allocation decoder 910 and the second contiguous resource allocation decoder 920 may be implemented as one element or program, or as separate elements or programs, in software or hardware. Particularly, the first contiguous resource allocation decoder 910 and the second contiguous resource allocation decoder 920 may perform decoding sequentially or parallely as one decoder.

The joint decoder 930 is matched to the joint encoder 530 illustrated in FIG. 5. The joint decoder 930 may decode contiguous resource allocation values RA₁ and RA₂ of a first component carrier and a second component carrier from a resource allocation field value RA of the PDCCH by using joint-decoding. Specifically, the joint decoder 930 divides the resource allocation field value RA of the PDCCH by the value of RAᵢ^{max}, decodes a remainder into the contiguous resource allocation value RA₁ of the first component carrier, and decodes a quotient into the contiguous resource allocation value RA₂ of the second component carrier. For example, when RA has a value of 641561 and RAᵢ^{max} has a value of 5050, a remainder is equal to 211 and a quotient is equal to 127. Accordingly, the remainder (=211) is decoded into RA₁, and the quotient (=127) is decoded into RA₂.

The first contiguous resource allocation decoder 910 and the second contiguous resource allocation decoder 920 receive, as input, the contiguous resource allocation values RA₁ and RA₂ of the first component carrier and the second component carrier from the joint decoder 930, respectively, and decodes an RIV, namely, a start point RBₛₜₐᵣₜ of an RBG and a length L_{CRBs} of contiguous virtual RBs by using N_{RB}^{DL} representing the total number of RBs, with respect to each of the first and second component carriers.

FIG. 10 is a view illustrating a configuration of an apparatus for decoding resource allocation information according to yet another embodiment of the present invention.

The apparatus 1000 for decoding resource allocation information according to yet another embodiment of the present invention decodes resource allocation information from control information of a PDCCH.

The apparatus 1000 for decoding resource allocation information includes a non-contiguous joint decoder 1030, a first enumerative source decoder 1010, and a second enumerative source decoder 1020.

The non-contiguous joint decoder 1030 is matched to the non-contiguous joint encoder 630 illustrated in FIG. 6. The non-contiguous joint decoder 1030 may decode non-contiguous resource allocation values RA₁ and RA₂ of a first component carrier and a second component carrier from a resource allocation field value RA of the PDCCH by using joint-decoding. Specifically, the non-contiguous joint decoder 1030 divides the resource allocation field value RA of the PDCCH by the value of RAᵢ^{max}, decodes a remainder into the non-contiguous resource allocation value RA₁ of the first component carrier, and decodes a quotient into the non-contiguous resource allocation value RA₂ of the second component carrier. For example, when RA has a value of 113097017 and RAᵢ^{max} has a value of 14950, a remainder is equal to 267 and a quotient is equal to 7567. Accordingly, the remainder (=7567) is decoded into RA₁, and the quotient (=127) is decoded into RA₂.

The first enumerative source decoder 1010 and the second enumerative source decoder 1020 receive, as input, the non-contiguous resource allocation values RA₁ and RA₂ of the first component carrier and the second component carriers from the non-contiguous joint decoder 1030, respectively, and decodes start points S₀ and S₂ and end points S₁−1 and S₃−1 of two clusters of each of the two component carriers in the case of non-contiguous contiguous resource allocation by using N_{RB}^{DL} representing the total number of RBs.

Hereinabove, the methods for decoding contiguous/non-contiguous resource allocation information in special conditions have been described with reference to FIG. 9 and FIG. 10. However, the present invention is not limited to this configuration. Specifically, according to exemplary embodiments of the present invention, one PDCCH includes resource allocation information of two or more component carriers, and it is possible to decode, in any form, the resource allocation information of the two or more component carriers.

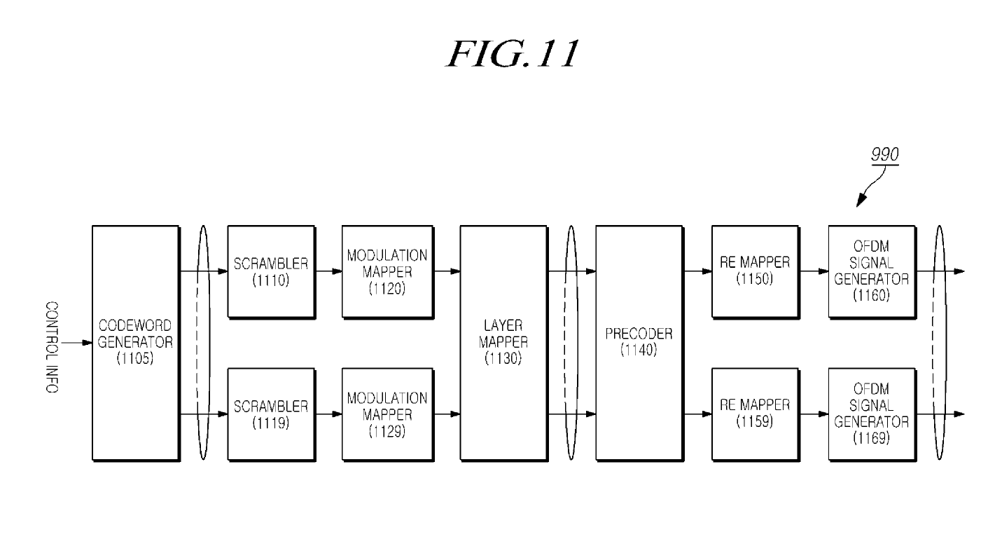

FIG. 11 is a block diagram illustrating a configuration of a BS which generates control information in DL, according to still another embodiment of the present invention.

Referring to FIG. 1 and FIG. 11, in a signal generator 990, a codeword generator 1105, scramblers 1110 and 1119, modulation mappers 1120 and 1129, a layer mapper 1130, a precoder 1140, Resource Element (RE) mappers 1150 and 1159, and Orthogonal Frequency Division Multiplexing (OFDM) signal generators 1160 and 1169 may exist as separate elements. Otherwise, two or more elements may be combined, and the combined elements may operate as one unit.

The control information to which the CRC is added as described above, is input to the signal generator 990.

The control information to which the CRC is added is generated as an OFDM signal by the codeword generator 1105, the scramblers 1110 and 1119, the modulation mappers 1120 and 1129, the layer mapper 1130, the precoder 1140, the RE mappers 1150 and 1159, and the OFDM signal generators 1160 and 1169. Then, the generated OFDM signal is transmitted to the UE through an antenna.

While an OFDM signal is generated as illustrated in FIG. 11, precoding may be omitted in a process for generating a PDCCH, and thereby the input and output of precoding may be identical. Also, after a codeword is generated, the generated codeword may not pass through multiple paths. Tailbiting Convolutional Coding (TCC) may be used to generate a PDCCH, and an operation related to Rate Matching (RM) may be applied to the generation of a PDCCH.

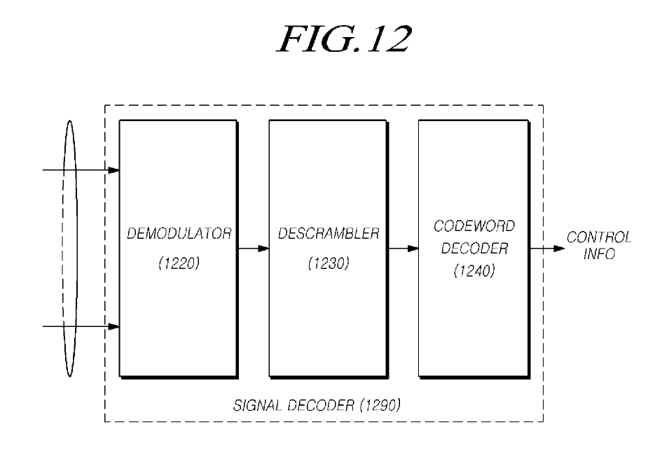

FIG. 12 is a block diagram illustrating a configuration of a UE according to still another embodiment of the present invention.

Referring to FIG. 1 and FIG. 12, the UE receives a signal from the BS through an antenna.

A demodulator 1220 provides a function of demodulating the received signal. When the BS transmits an OFDM signal, the UE demodulates the received signal in the OFDM scheme. Otherwise, according to whether the BS generates a signal in an FDD scheme or in a TDD scheme, the UE may demodulate the received signal in the relevant scheme.

The demodulated signal is descrambled by a descrambler 1230, and thereby a codeword having a predetermined length is generated. A codeword decoder 1240 again reconstructs predetermined control information from the generated codeword. This function may be performed at one time by a signal decoder 1290. Otherwise, this function may be performed independently or sequentially by two or more elements.

Finally, resource allocation information is interpreted from this reconstructed control information by an upper layer higher than a physical layer which reconstructs a signal.

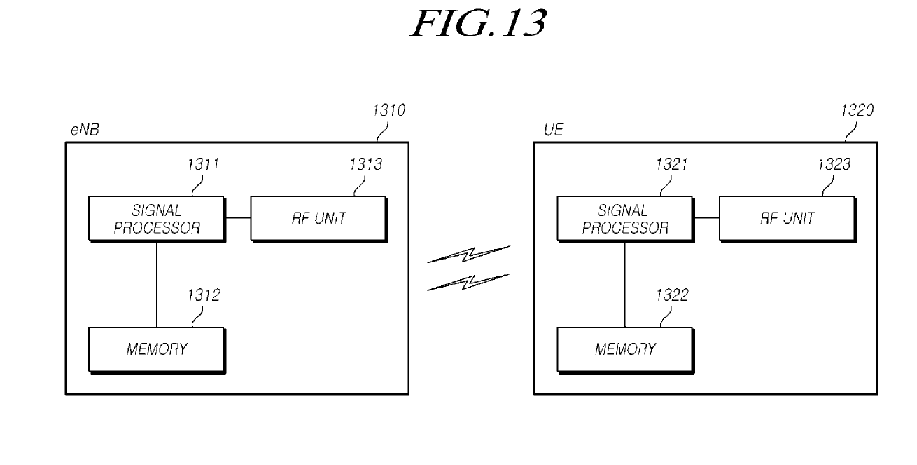

FIG. 13 is a block diagram schematically illustrating a configuration of a wireless communication system, by which exemplary embodiments of the present invention are implemented.

Referring to FIG. 13, an evolved-NodeB (eNB) 1310 includes a signal processor 1311, a memory 1312, and a Radio Frequency (RF) unit 1313.

The signal processor 1311 implements functions, processes and/or methods, which are required to process the control information as described above.

The memory 1312 may be connected to the signal processor 1311, and may store a protocol or parameters for processing the control information, a transmission table required to allocate resources, and the like.

The RF unit 1313 may be connected to the signal processor 1311, and may transmit and/or receive wireless signals. The RF unit 1313 may include multiple antennas.

A UE 1320 includes a signal processor 1321, a memory 1322, and an RF unit 1323.

The signal processor 1321 implements functions, processes and/or methods, which are required to process the control information as described above.

The memory 1322 may be connected to the signal processor 1321, and may store a protocol or parameters for processing the control information, a signal transmission table identical to one included in the eNB 1310 in order to allocate resources, and the like.

The RF unit 1323 may be connected to the signal processor 1321, and may transmit and/or receive wireless signals. The RF unit 1323 may include multiple antennas.

Each of the signal processors 1311 and 1321 may include an Application-Specific Integrated Circuit (ASIC), another chipset, a logic circuit, and/or a data processing unit.

Each of the memories 1312 and 1322 may include a Read-Only Memory (ROM), a Random Access Memory (RAM), a flash memory, a memory card, a storage medium, and/or other storage units. Each of the RF units 1313 and 1323 may include a baseband circuit for processing a wireless signal. When exemplary embodiments of the present invention are implemented in software, the techniques as described above may be implemented by using modules (e.g., processes or functions) which perform the functions as described above. The modules may be stored in each of the memories 1312 and 1322, and may be executed by each of the signal processors 1311 and 1321. The memories 1312 and 1322 may exist within or outside the signal processors 1311 and 1321 and may be connected to the signal processors 1311 and 1321 via various well-known means, respectively.

The multiple pieces of control information that an upper layer delivers as described above can also be transmitted through a separate physical control channel, and can be periodically or aperiodically updated at a request from the BS or the UE, or according to predetermined rules or instructions.

The above description is only an illustrative description of the technical idea of the present invention, and those having ordinary knowledge in the technical field, to which the present invention pertains, will appreciate that various changes and modifications may be made to the embodiments described herein without departing from the essential features of the present invention. Therefore, the embodiments disclosed in the present invention are intended not to limit but to describe the technical idea of the present invention, and thus do not limit the scope of the technical idea of the present invention. The protection scope of the present invention should be construed based on the appended claims, and all of the technical ideas included within the scope equivalent to the appended claims should be construed as being included within the right scope of the present invention.

1. A method for transmitting control information in a communication system where communication is performed by using two or more component carriers, the method comprising:
receiving, as an input, coefficients required to indicate resource allocation, and encoding the coefficients into a resource allocation value of each of the two or more component carriers;
generating one piece of resource allocation information by joint-encoding the resource allocation values; and
transmitting control information including the resource allocation information to a user equipment through a control channel.

2. The method as claimed in claim 1, wherein the resource allocation information (RA) is generated by joint-encoding the resource allocation values by using
$$RA = {\sum }_{i = 2}^{m} ( {RA}_{i} \cdot ( {\prod }_{l = 1}^{i - 1} {RA}_{l}^{max} ) ) + {RA}_{1} ,$$
wherein RAᵢ represents a resource allocation value of an i-th component carrier, RAᵢ^{max} represents a maximum value of a resource allocation value of a first component carrier, and m represents the number of component carriers.

3. The method as claimed in claim 1, wherein the resource allocation corresponds to either contiguous resource allocation or non-contiguous resource allocation.

4. The method as claimed in claim 3, wherein, when the resource allocation corresponds to the non-contiguous resource allocation, the coefficients are received as an input and the coefficients are encoded into the non-contiguous resource allocation value of each of the two or more component carriers, by using enumerative source encoding.

5. The method as claimed in claim 3, wherein the resource allocation value of each of the two or more component carriers is expressed by a combinatorial index (r), when non-contiguous resource block group sets are allocated as non-contiguous resources; and the resource allocation value of each of the two or more component carriers is expressed by using a resource indication value (RIV_{LTE}(L_{CRBs}, RBₛₜₐᵣₜ, N_{RB}^{DL})) corresponding to both a start point (RBₛₜₐᵣₜ) of a resource block group and a length (L_{CRBs}) of contiguous virtual resource blocks, during the contiguous resource allocation.

6. A method for processing control information in a communication system where communication is performed by using two or more component carriers, the method comprising:
receiving control information including resource allocation information from a base station through a control channel;
decoding a resource allocation value of each of the two or more component carriers from the resource allocation information of the control information by using joint-decoding; and
decoding coefficients required to indicate resource allocation on the two or more component carriers from the decoded resource allocation value of each of the two or more component carriers.

7. The method as claimed in claim 6, wherein the resource allocation information of the control information is joint-decoded into the resource allocation value of each of the two or more component carriers by using
$$RA = {\sum }_{i = 2}^{m} ( {RA}_{i} \cdot ( {\prod }_{l = 1}^{i - 1} {RA}_{l}^{max} ) ) + {RA}_{1} ,$$
wherein RAᵢ represents a resource allocation value of an i-th component carrier, RA₁^{max} represents a maximum value of a resource allocation value of the first component carrier, and m represents the number of component carriers.

8. The method as claimed in claim 6, wherein the resource allocation corresponds to either contiguous resource allocation or non-contiguous resource allocation.

9. The method as claimed in claim 8, wherein, when the resource allocation corresponds to the non-contiguous resource allocation, the coefficients are decoded from the non-contiguous resource allocation value of each of the two or more component carriers by using enumerative source decoding.

10. The method as claimed in claim 8, wherein the resource allocation value of each of the two or more component carriers is expressed by a combinatorial index (r), when non-contiguous resource block group sets are allocated as non-contiguous resources; and the resource allocation value of each of the two or more component carriers is expressed by using a resource indication value (RIV_{LTE}(L_{CRBs}, RBₛₜₐᵣₜ, N_{RB}^{DL})) corresponding to both a start point (RBₛₜₐᵣₜ) of a resource block group and a length (L_{CRBs}) of contiguous virtual resource blocks, during the contiguous resource allocation.

11. An apparatus for allocating resources in a communication system where communication is performed by using two or more component carriers, the apparatus comprising:
a first encoder for receiving, as an input, coefficients required to indicate resource allocation, and encoding the coefficients into a resource allocation value of each of the two or more component carriers; and
a joint encoder for generating one piece of resource allocation information by joint-encoding the resource allocation values.

12. An apparatus for decoding resource allocation information in a communication system where communication is performed by using two or more component carriers, the apparatus comprising:
a joint decoder for decoding a resource allocation value of each of the two or more component carriers from resource allocation information of control information received from a base station by using joint-decoding; and
a first decoder for decoding coefficients required to indicate resource allocation on the two or more component carriers from the resource allocation value of each of the two or more component carriers which has been decoded by the joint decoder.
